(19) United States
(12) Patent Application Publication
(10) Pub. No.: US 2003/0195762 A1
(43) Pub. Date: Oct. 16, 2003

(54) Automated workflow

(76) Inventors: David Gleason, Sharon, MA (US); Michael Clifton, Salem, NH (US); James F. Maniscalco, East Milton, MA (US); Stephen Farrington, Wolverhampton (GB)

Correspondence Address: FISH & RICHARDSON PC, 225 FRANKLIN ST, BOSTON, MA, 02110, US

(21) Appl. No.: 10/271,705

(22) Filed: Oct. 15, 2002

Related U.S. Application Data
(60) Provisional application No. 60/372,244, filed on Apr. 12, 2002.

(51) Int. Cl. G06F 17/60

(52) U.S. Cl. 705/1

(57) ABSTRACT

An automatic workflow architecture provides a design and execution environment for computer-automating business processes, where a user knowledgeable only in the business process itself can create and run the automation of the process without assistance from programmers. An automated workflow method including loading a blank document, selecting activities from a menu to reflect a flow of a business process, inserting the selected activities into the document, assigning variables to the selected activities, and assigning the variables to fields within a desktop application.

### TECHNICAL FIELD

This invention relates to automated workflow.

### BACKGROUND

As computer applications have become more sophisticated, they have evolved from automation of single tasks, such as entry of a new sales order into a database, to automation of entire processes, such as routing of a new sales order through consecutive levels of approvals and then to the various functions necessary to produce, ship, and invoice that order. For example, a user knowledgeable in a business activity describes a process and associated tasks to be accomplished to a systems analyst, architect, or programmer. The user may use various tools, such as a scripting language or a graphical modeling language, to simplify generating this description for the systems analyst. From the description, the systems analyst builds a business application. This often results in application development efforts that are time-and resource-consuming due to, for example, a disconnect between the user who understands the business process but does not understand programming, and the systems analyst who understands programming and not the business process.

### SUMMARY

In an aspect, the invention features a workflow method including specifying data sources and participants for a business process, integrating input and output forms for the business process, invoking a decision-tree based map using icons that represent elements of business rules that can be dragged and dropped into a graphical user interface workspace, and linking input from the input and output forms to dynamic variables within the decision-tree based map.

One or more of the following features may also be included. The method may include storing and evaluating the business rules in a server-based engine, sending data to external systems, and executing the business process. The server-based engine may communicate with external systems using a Simple Object Access Protocol (SOAP).

Specifying may include receiving a user input through a desktop application. The desktop application may be a spreadsheet application or a word processing application.

The method may also include managing communications using electronic mail or using a web portal.

The method may also include tracking a status of the business process.

In another aspect, the invention features an automated workflow method including loading a graphical user interface workspace, selecting activities from a menu to reflect a flow of a business process, inserting the selected activities into the workspace, assigning variables to the selected activities, and assigning the variables to fields within a desktop application.

One or more of the following features may also be included. The workspace may be a spreadsheet or a word processing document. The desktop application may be a spreadsheet program or a word processing program.

The method may also include executing the selected activities.

In another aspect, the invention features a network including a client system linked to an application server through a web server, the client system including a desktop application, an Add-In using COM objects to host application server functions and variable mapping logging, and MS SOAP client, the web server including an Apache SOAP servlet that hosts SOAP services, and the application server including a process engine for executing an automated work flow process.

One or more of the following features may also be included. The network may also include a link between the client system and the web server for passing SOAP/HTTP requests and responses and a link between the web server and the application server for handling remote method invocation (RMI) functions.

In another aspect, the invention features a graphical user interface (GUI) including a map representing a business process flow with input and output, a start and end activity destination, activity assignments, and a rule set linked to each of the activity assignments.

One or more of the following features may also be included. The rule set may include a set of user customizable parameters and variables.

The interface may include a link to a desktop application, and the desktop application may be a spreadsheet and/or document.

Embodiments of the invention may have one or more of the following advantages.

A system enables development of and execution of, business process applications without programming. The system includes a graphical user (GUI) interface to specify data sources and participants, to provide and integrate input and output forms, design and invoke a decision-tree based process map using simple drag and drop business rules and connect inputs from forms to dynamic variables within the process map. A server-based engine is used to store and evaluate rules, send or retrieve data from external systems, execute processes, manage communication via email or web portals, and track status. A user can invoke the process to execute immediately or by a schedule.

In a process engine business rules are process categorized into library sets that may be grouped according to single applications or similarity of function. These library sets can be exported and imported as neutral files between implementations. An individual rule or a rule library set may be devoted to a web service.

A web service is a rule or action within a rule that interacts within an external system via the web, for the purpose of querying and retrieving a response from an external system, which response is the input to the next rule or activity within the business process.

The system provides a design and execution environment for automating business processes where a user knowledgeable only in the business process itself can generate and run the automation of that process without assistance from programmers or other computer technicians.

The system makes the development of business process enabled applications accessible directly by a user such that development can be dramatically reduced by eliminating the translation step between a user and a software developer and corresponding iterations. Many more applications may be developed because many more people can develop them.

Users of the system are able to define a process and associate the responsible parties. The use may link the data if required and organize the logic to generate the desired result. Once a definition is complete, the user can generate a set of variables that, in addition to being one output of the application, can control decisions and flow of the business process, thus making the process dynamic and adaptive to external business conditions. This is referred to as externalizing business logic. The variables are bound to the process. Access to view or change variables, i.e., input forms, of the application can be developed solely by the user using desktop applications such as Microsoft Excel®, Microsoft Word® or Microsoft Access®.

The process integrates standard desktop tools (i.e., applications), such as Excel®, into the development environment. The locations, cells or fields of the desktop tool are associated with variables useable within the application. The non-programmer user may make these associations in an intuitive, graphical manner. The application may use the contents of these variables both as retrievable and manipulable data, and as decision inputs to the process itself, in effect generating some of the logic that drives the application. The input forms produced can be executed on a standard desktop tool on the participants' workstations and communicate the values input back to the business application executing on a server.

A business process management server is designated to allow data, assignment of people or groups, and separation of processing logic.

The business process management server encompasses individual rules and sets of rules that are configurable by the use of variables assigned and generated within a desktop interface.

The method provides a desktop tool when used in conjunction with a business process management server makes generating access to existing process definitions and variables and intuitive.

A graphical user interface (GUI) is provided for the assignment of documents or sheets that represent a library of files that are dynamically delivered as a process is executed.

The method provides an architectural design that allows for a Java® 2 Enterprise Edition (J2EE) business process management engine to access a Microsoft COM® (Component Object Model) through the use of a SOAP (Simple Object Access Protocol)/XML (eXtensible Mark up Language) services.

Other features, objects, and advantages of the invention will be apparent from the description and drawings, and from the claims.

### DESCRIPTION OF DRAWINGS

FIG. 1 is a block diagram of a network.

FIG. 2 is a block diagram of a graphical user interface (GUI).

FIG. 3 is a flow diagram of an automated workflow process.

### DETAILED DESCRIPTION

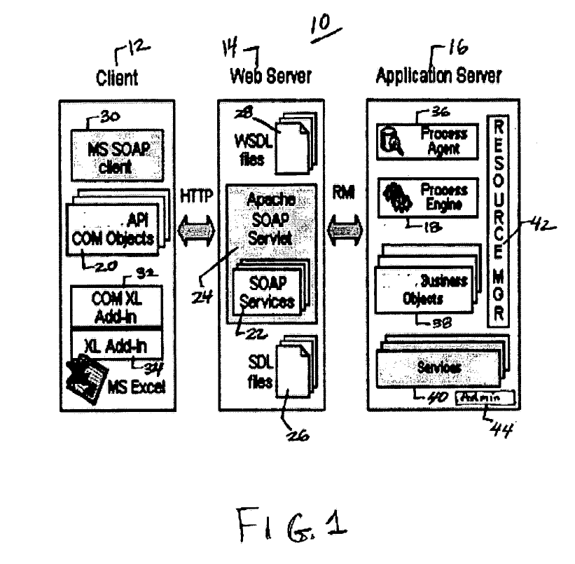

Referring to FIG. 1, a network 10 includes a client system 12, a web server 14 and an application server 16. In an example, the client system 12 is a personal computer, such as a desktop computer or laptop computer, capable of running desktop applications, such as those contained in Microsoft Office or Corel WordPerfect Office, in a Microsoft Windows® or Linux operating system (O/S).

In general, a web server is a system that, using a client/server model and the World Wide Web's (web) Hypertext Transfer Protocol (HTTP), serves files that form web pages to web users whose computers, such as client system 12, contain HTTP clients that forward their requests. In general, an application server is a system having a server program and located in a network, such as network 10, which provides business logic for an application program. Communication between the client system 12 and the web server 14 is via HTTP. HTTP is the set of rules for exchanging files (text, graphic images, sound, video, and other multimedia files) on, for example, the web. Relative to the TCP/IP suite of protocols (which are the basis for information exchange on the Internet), HTTP is an application protocol.

Communication between the web server 14 and the application server 16 is, for example, Remote Method Invocation (RMI). RMI is a way that a programmer, using the Java® programming language and development environment from Sun Microsystems, Inc., writes object-oriented programming in which objects on different computers may interact in a distributed network. RMI is a Java® version of what is generally known as a remote procedure call (RPC), but with an ability to pass one or more objects along with the request. An object may include information that changes a service that is performed in a remote computer.

A process engine 18 runs in the application server 16. SOAP protocol defines the format of XML messages that are used to communicate between client objects 20 residing in the client system 12 and the application server 16. Simple Object Access Protocol (SOAP) is a way for a program running in one kind of operating system, such as Microsoft Windows®, to communicate with a program in the same or another kind of an operating system, such as Linux, by using the web's HTTP and its Extensible Markup Language (XML) as mechanisms for information exchange. Using a standard format based on XML means that SOAP can be used to communicate with the process engine 18 via multiple computer architectures, languages, and operating systems.

SOAP services 22 are hosted by an Apache SOAP Listener servlet 24 running on the web server 14. The Listener 24 takes HTTP SOAP requests and maps them to method calls within the application server 16. These services include a Service Descriptive Language (SDL) file 26 used by Apache SOAP 24 when registering the service, a Web Services Descriptive Language (WSDL) file 28 used by the client objects 20 when accessing the services 22, and standard Java® classes or Enterprise Java®Beans (EJBs) that implement the services 22.

An MS SOAP client 30 in the client system 12 is used to generate requests to the SOAP services 22, receive responses and perform any general error handling. There are also a number of additional Component Object Model (COM) objects 20 that simplify access by converting XML requests into strongly typed COM collections, and provide a client based caching layer.

In COM, software components communicate by interfaces, i.e., objects that are implemented by a server component and used by a client component. An interface is a pointer to a block of memory in which, like a C++ class, the first word is a pointer to a table of function addresses (called a virtual function table or v-table). Interfaces are identified by UUIDs, unique 16-byte values, and described with Interface Description Language (IDL). These descriptions allow the interfaces to be used from various programming languages.

The client uses the interface by calling the functions from the table (referred to as methods of the interface), passing the interface pointer itself as the first argument, with additional arguments depending on the particular function. For all interfaces, the first three elements of the v-table are the methods QueryInterface, AddRef, and Release. An interface that supports only these three methods is called an IUnknown interface, and all other interfaces are said to inherit from IUnknown. QueryInterface is used to obtain additional interface pointers supported by the object, while AddRef and Release increment and decrement a reference count to enable the server to know when all clients have finished using the interface.

The client uses the interface only through its v-table, not by directly accessing any of the memory locations beyond the v-table pointer. This is because the object may actually be nothing more than a proxy whose functions forward the argument values to the real object in another process.

In an example, an XL Add-In 32 uses the COM objects 20 and includes a standard Microsoft Excel Add-In (.XLA) file 34, an accompanying worker DLL that hosts the application server 16 functions and variable mapping logic. Add-In is a term used for a software utility or other program that can be added to a primary program. A DLL (dynamic link library) is a collection of small programs, any of which can be called when needed by a larger program that is running in the computer. The smaller program that lets the larger program communicate with a specific device such as a printer or scanner is often packaged as a DLL program (usually referred to as a DLL file). DLL files that support specific device operations are known as device drivers.

Process variables are defined at the process engine 18 and generated dynamically by the process engine 18 when used for the first time. A global variable is a variable generated when the process engine 18 is initialized and is maintained until the process engine 18 is shutdown. It is made available to all areas that have access to it. A process variable is generated at the point it is used for the first time within a business process and maintained until that business process is complete. The process variable is made available to all activities and process rules within a business process.

An activity variable is generated at the point it is used for the first time within a business process activity and maintained until the business process activity is complete. The activity variable is made available to all process rules within the business process activity.

Within the bounds of the above role definitions and scope the variables are made available to the process engine 18 implicitly when referenced, or explicitly as follows. A process rule API (not shown) allows rules written as Java® classes to generate and access variables programmatically. The process rule API allows external applications to generate, access, and view variables and their values.

Variables are categorized into two main types, i.e., application variables and data variables. Application variables are generated by assigning values to a named variable, and in most cases represent a single value that is used to determine a logic or a flow of an application. Global variables are classified as application variables. Global variables have the minimal property information of name, value, and type.

Data variables are named variables where the values are assigned automatically as a target for information retrieved from a data source. Data variables are used to more easily represent and manipulate database values within the process engine 18, and have more metadata than application variables in the form of name, value, type, and dimensionality. A single data variable can be two-dimensional and therefore represent a matrix of data in the form of rows and columns. In this example, individual variables can optionally be generated for each column in a matrix, at which point the convention of “VariableName.MatrixColumnName” is used to name each of the variables.

An XML/SOAP API (not shown) exposes a main API to multiple operating systems and languages. Any client application capable of generating an HTML request that complies with the SOAP standard, and that conforms to a request layout described in WSDL file 28, can use SOAP services 22 as a way of communicating with the process engine 18.

For example, for ease of use in a Microsoft Desktop environment, the MS SOAP client 30 is used to construct XML packets that represent API functions and method calls as described in the WSDL file 28. The MS SOAP client 30 is also used to parse responses and handle general SOAP errors. Other SOAP clients may be used to perform this functionality, or the XML and HTTP requests coded natively. In all cases, the information returned is in the form of an XML document containing complex elements. An example is shown as follows:

<?xml version=“1.0” encoding=“UTF-8”?>
<metadata xmlns:noNameSpaceSchemaLocation=“http://TEST1:8080/NobilisSOAP/Metadata.xsd”>

<variable>

<objectName>MONTH</objectName>
<value>FEBRUARY</value>
<scope>1</scope>
<type>1</type>
<processInstanceId>2</processInstanceId>
<userId>0</userId>
<objectId>3</objectId>

<activityInstanceId>7</activityInstanceId>

</variable>
<variable>

<objectName>DAY</objectName>

<value>28</value>
<scope>0</scope>
<type>1</type>

<processInstanceId>2</processInstanceId>
<userId>0</userId>
<objectId>6</objectId>
<activityInstanceId>0</activityInstanceId>

</variable>

</metadata>

A process agent 36 in the application server 16 executes in conjunction with the process engine 18 and acts as a high level listener for external requests and internal interrupts. The process agent 36 includes a number of components to address various types of requests. For example, the process agent 36 includes an HTTP listener component, a JMS listener component, an XML listener component and a time-out component.

When the process agent 36 finds any requests to handle, the process agent 36 also checks for the availability of free threads within the process engine 18. If there is a thread available, the process agent 36 will initiate the handling of the request.

The HTTP listener component of the process agent 36 is used for external HTTP/XML messages.

The JMS (Java® Message Service) listener component of the process agent 36 monitors JMS message queues. Java® Message Service is an Application Program Interface (API) from Sun Microsystems that supports a formal communication known as messaging between computers in a network. Sun's JMS provides a common interface to standard messaging protocols and also to special messaging services in support of Java® programs. The messages involved exchange data between computers rather than between users and contain information such as event notification and service requests. Messaging is used to coordinate programs in dissimilar systems or written in different programming languages. JMS supports messages that contain serialized Java® objects and messages that contain eXtensible Markup Language (XML) pages.

The XML listener component of the process agent 36 is used for API requests.

The time-out component of the process agent 36 is used to check for an expiration of deadlines set by process rules.

Business objects 38 are a collection of individual objects provided to facilitate the running of processes by the process engine 18. The business objects 38 are a combination of EJBS (Enterprise Java® Beans) entity and session beans.

Enterprise beans are the J2EE components that implement Enterprise Java®Beans (EJB) technology. Enterprise beans run in the EJB container, a runtime environment within a J2EE server. Although transparent to the application developer, the EJB container provides system-level services such as transactions to its enterprise beans. These services enable one to quickly build and deploy enterprise beans, which form a core of transactional J2EE applications. Written in the Java® programming language, an enterprise bean is a server-side component that encapsulates the business logic of an application. The business logic is the code that fulfills the purpose of the application. By invoking these methods, remote clients can access the inventory services provided by the application.

A session bean represents a single client inside a J2EE server. To access an application that is deployed on the server, the client invokes the session bean's methods. The session bean performs work for its client, shielding the client from complexity by executing business tasks inside the server. A session bean is not shared (it may have just one client, in the same way that an interactive session may have just one user). Like an interactive session, a session bean is not persistent, i.e., its data is not saved to a database. When the client terminates, its session bean appears to terminate and is no longer associated with the client.

The business objects 38 include process rules, a process rules engine, data manager and plug-ins, application context, process agent worker and report objects.

Services 40 refer to common services provided by the application server 16, such as object cache management, transaction control, clustering, data sources and messaging. The number of services provided, and the level to which they are provided, varies across different application servers.

A resource manager 42 residing in the application server 16 provides a definition of views on external data, and a further sub-definition and access of these views by individual processes. There are also a number of API requests provided that allows access to the data defined in the views from user written process rules. Example data types are relational databases, (such as Oracle®, SQLServer® and Access®), multi-dimensional databases (such as Hyperion Essbase®), and documents.

For ease of use in a Microsoft Desktop environment, and specifically for Microsoft Visual Basis (VB) or Microsoft Visual Basic For Applications (VBA) access, there are a number of COM objects 20 provided that wrapper the MS SOAP client 30 and generate strongly typed values for each of the API function properties and methods, and return values. For example,

Dim app As New NOBILISSOAPLib.Application

Dim MONTH As New NOBILISSOAPLib.Variable

app.InitializeFromRegistry

Set MONTH=app.Variable(“FEBRUARY”)

MsgBox “The Month is: ” &MONTH.value

The COM layer additionally provides a local cache (not shown) capability for the API information. Performance is improved as any information already returned from a server based process engine 18 remains available locally at the client 12. The cache layer can persist itself to disk and therefore a client application can be coded to continue working while disconnected from the process engine 18. Method calls are provided in the COM layer to allow the cache to be refreshed from the process engine 18 and so reflect any updated information. Variables in the cache can be updated locally and reflected in the local application without having to update the values directly in the process engine 18. Applications that input or amend data on an iterative basis before arriving at the final values, such as Budgeting or What-if, can take advantage of this. Method calls are also provided to allow all of the variables that have been updated in the cache to be written back to the process engine 18 in one operation.

Using Microsoft Excel® as a desktop application example, the Excel Add-In 34 talks to the process engine 18 by using the local COM objects 20 to drive the XML/SOAP API layer. In addition to the above client objects there are two modules for the Add-In 34. First, a filename.XLA is registered within Microsoft Excel® as a standard Add-In and allows a close integration with the Microsoft Excel® user interface (UI) components such as Toolbar, Menus and Functions list. The Add-In 34 also monitors events. Second, file.DLL is a “worker” DLL containing a main body of the Add-In functionality and the interaction with the process engine 18 via the COM objects 20 and API.

When requested by a running process, the process engine 18 sends a notification to a user that a specific application is ready to run. The notification contains a Universal Resource Locator (URL) with an encrypted key that holds user and process instance information for connection back to the process engine 18. If the application named in the URL relates to an Excel®) workbook file it will be automatically downloaded from a document library and a shell execute performed to invoke Excel®. The initial connection back to the process engine 18 checks to see if the user has the Add-In 34 installed on their computer system, e.g., client system 12, and if not, the full set of client components are automatically downloaded from a defined Web server to the user's system, and the Add-In 34 is installed and registered as part of the invocation of Excel®.

When the Add-In 34 is installed, the user connects to the process engine 18 implicitly, which is done using embedded key information in a notification from a running process, or explicitly, by using a connect option within the Add-In 34 and entering login and password information. Once connected the Add-In 34 provides options via a menu, toolbar, and the Excel® function list.

An administrator 44 is an application that is provided to allow the administration and customization of the process engine 18. The administrator application is installed as a .WAR file, and is automatically deployed on the application server 16 when the server component is started. Functionality is also provided for the managing of users within an addressbook, definition of individual business processes including specification of data resources used and the scope of these resources, specification of the participants (users) for a process, and specification of process rules and conditional execution (logic) of the rules. Functionality is provided for definition of data resources including external databases/tables to be accessed and filters (in the form of queries) to apply when reading these resources, definition of document libraries and the uploading of external documents, and the management of business processes. The management of business processes include initial running of defined processes, monitoring of running processes (including real time status reports, viewing and filtering of process log information and the pausing/canceling of running processes and scheduling of processes), and general configuration settings for the process engine 18 (such as address of SMTP server for e-mail messages, defining global variables and their values, setting options for the process log file).

Individual business processes include, for example, specification of data resources used and the scope of these resources, specification of users for a process, and specification of process rules and conditional execution (logic) of the rules.

Data resources include, for example, external databases/tables to be accessed and filters (in the form of queries) to apply when reading these resources.

Business processes include, for example, an initial running of defined processes.

Monitoring of running processes include, for example, real time status reports, viewing and filtering of process log information, and pause/cancel of running processes.

General configuration settings for the process engine 18 include, for example, an address of SMTP server for E-mail messages, definition of global variables and their values, and setting options for the process log file. These options include, for example, columns to be displayed, order to display columns, and deletion of entries based on date.

Options are provided on the Excel® Add-In 34 tool bar that enable the above functionality from within the add-in. This is achieved via hosting a browser control within a Windows® dialog as part of the Add-In 34 UI components, and connecting to the main administration application on the server component.

Additional functionality on the Add-In 34 toolbar includes a resource manager for the management of external data definitions and process writer settings for the configuration settings of the process engine.

The above toolbar options are displayed conditionally based on the role values for a new name and log-in as defined in the address book. The embedded browser control is used to connect to the process engine 18 and uses a subset of the administrator 44 to provide the following facilities:

An inbox acts as an alternative to a conventional E-mail inbox and can be used as a notification queue for messages sent from the process engine 18. As with a standard e-mail inbox, clicking on an entry invokes the associated application. For example, if the associated application is an Excel® based application, the defined workbook is opened in the same Excel® session and made the active workbook.

The process engine 18 provides a user manager that allows manipulation of users, groups and roles in an address book. The process engine 18 provides a document manager that handles loading and management of documents in document libraries. The process engine 18 provides a process designer that handles generation and editing of business processes and process rulesets. The process engine 18 provides a process manager that handles running or scheduling of business processes, as well as monitoring the progress of active processes and displaying log information for processes that have run. The process engine 18 provides a help function that provides access to an on-line help system for the above functionality.

When a connection is made to the process engine 18 it is in the context of a named user via a login dialog or in the context of a running process and therefore the associated user for the activity instance running the application. In both cases the above areas of functionality are only available if the context determines that the user role definitions permit the use of the functionality.

The context and associated user will also determine the scope and content of the accessible information. Even if the user has access to a particular area of functionality they will only be able to apply that functionality to the resources permitted by their role definitions.

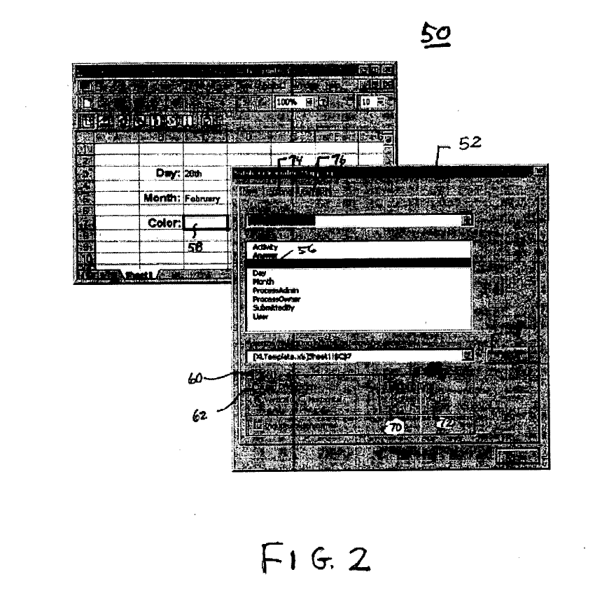

Referring to FIG. 2, a graphical user interface (GUI) 50 is shown. When the Add-In 34 is invoked from a running process the context information for that process includes any variables currently in scope. The Add-In 32, as mentioned above, includes two modules, i.e., a standard XL Add-In 34 and a “worker” DLL. These two components are collectively referred to as the Excel® Add-In 34. Variables can be linked to Excel® cells within an Excel® workbook GUI 50 by using a variable mapping option. Selecting the variable mapping option causes display of a variable mapping dialog 52.

When a variable mapping option 52 is selected the Add-In 34 requests a list of variables currently in scope via an API call to the process engine 18 and display the results in the variable mapping dialog 52. The dialog 52 provides selection of a variable name and a cell within the Excel® workbook GUI 50. For example, when the add button 54 is pressed a link is generated between the variable name “color” 56 and cell 58 and the specification stored as a hidden value in the Excel® workbook GUI 50.

For application variables the cell reference 58 is used as a target and source cell for updates of the variable to and from a local cache maintained by the COM layer. The local cache is generated and managed by the COM objects 20 and persisted to the client user's local disk.

For data variables the cell reference 58 is the first element (top left hand corner) of a matrix defined by the variable.

The dialog 52 includes a layout section 60.

Additional options are available for data variables. For example, a layout (column orientation) option 62 defines how the matrix row/columns should be presented as cells in the Excel® worksheet. There is a vertical 64 and a horizontal 66 option. A layout (mapping type) option 68 specifies how multiple elements in a variable should be mapped to the worksheet.

A field option 70 displays how each of the elements are linked as an individual field when the original mapping is performed. This is applicable when using a worksheet as a form, and allows the individually mapped cells to be moved around the workbook while still maintaining the link to the variable.

A list option 72 displays the elements in a variable and how they are treated as a dynamic list and the starting point (top left corner) of the matrix is the only cell linked. This is used when the worksheet to display lists that have a varying number of elements.

An “Existing” tab option 72 allows the viewing and management of existing links showing the type and number of mappings for each variable.

A “Refresh” tab option 76 provides a graphical method of refreshing the worksheet cells, variables held locally in the cache, and variables in the context of the process.

Continuing with Microsoft Excel® as an example, the process engine 18 can open a worksheet in one of two modes. In a design mode the toolbar and menu options are displayed and the user has the ability to map or re-map variables to cells in the worksheet. The user may also modify the worksheet and is automatically prompted to re-save the worksheet when any changes are made. A design mode password may also be defined for the worksheet.

In a run mode the toolbar is not displayed, and the only menu option available is design mode to permit the user to switch back into design mode. If a design mode password has been defined for the worksheet then the user is prompted for the password when the menu option is selected.

A number of process functions are provided as part of the standard Excel® function dialog. These process functions allow an Excel® application designer to perform operations that are part of the API from within the Excel® environment and context.

There are also a number of macros provided for use in VBA (Microsoft Visual Basic for Applications) code. These macros can be used to perform cell, cached variables, and process variables updates programmatically rather than using the graphical dialog control.

A return( ) macro ends the application context for the workbook and issues a return to the business process running at the process engine 18. Return( ) can be used without any parameters and can therefore be used external to VBA code.

The Add-In 34 interfaces with Excel® functionality for User Interface (UI) operations and the storing/retrieving of data (including control information) in the workbook. All other operations make use of APIs to interact with the local cache and the process engine 18.

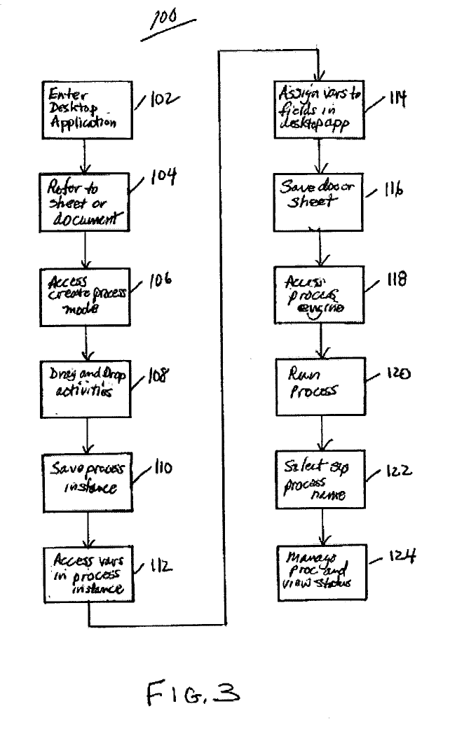

Referring to FIG. 3, an automated workflow process 100 includes entering (102) a desktop application. Example desktop applications are Microsoft Excel®, Microsoft Access®, and Microsoft Word®. A user refers (104) to a workspace blank or existing sheet or document within the desktop application. A user clicks on a system button to access (106) a create process mode. The user drags and drops (108) standard activities from a menu into the sheet to reflect flow of a process. The process 100 saves (110) the process instance. The user clicks a system button to access (112) variables in a process instant mode. The user assigns (114) variables to fields within the desktop application. The process 100 saves (116) the document or sheet. The user clicks system button to access (118) the process engine and run (120) the process. The user selects (122) a system process name and clicks (124) a system manage process and views process status options.

What is claimed is:

1. A workflow method comprising:
specifying data sources and participants for a business process;
integrating input and output forms for the business process;
invoking a decision-tree based map using icons that represent elements of business rules that can be dragged and dropped into graphical user interface work space; and
linking input from the input and output forms to dynamic variables within the decision-tree based map.

2. The method of claim 1 further comprising:
storing and evaluating the business rules in a server-based engine;
sending data to external systems; and
executing the business process.

3. The method of claim 2 in which the server-based engine communicates with external systems using a Simple Object Access Protocol (SOAP).

4. The method of claim 1 in which specifying comprises receiving a user input through a desktop application.

5. The method of claim 4 in which the desktop application is a spreadsheet application.

6. The method of claim 4 in which the desktop application is a word processing application.

7. The method of claim 2 further comprising managing communications using electronic mail.

8. The method of claim 2 further comprising managing communications using a web portal.

9. The method of claim 2 further comprising tracking a status of the business process.

10. An automated workflow method comprising:
loading a graphical user interface workspace;
selecting activities from a menu to reflect a flow of a business process;
inserting the selected activities into the workspace;
assigning variables to the selected activities; and
assigning the variables to fields within a desktop application.

11. The method of claim 10 in which the workspace is a spreadsheet.

12. The method of claim 11 in which the workspace is a spreadsheet program.

13. The method of claim 10 in which the workspace is a word processing document.

14. The method of claim 13 in which the desktop application is a word processing program.

15. The method of claim 10 further comprising executing the selected activities.

16. A network comprising:
a client system linked to an application server through a web server, the client system including a desktop application, an Add-In using COM objects to host application server functions and variable mapping logging, and MS SOAP client;
the web server including an Apache SOAP servlet that hosts SOAP services; and
the application server including a process engine for executing an automated work flow process.

17. The network of claim 16 further comprising a link between the client system and the web server for passing SOAP/HTTP requests and responses.

18. The method of claim 16 further comprising a link between the web server and the application server for handling remote method invocation (RMI) functions.

19. A graphical user interface (GUI) comprising:
a map representing a business process flow with input and output;
a start and end activity destination;
activity assignments; and
a rule set linked to each of the activity assignments.

20. The interface of claim 19 in which the rule set comprises a set of user customizable parameters and variables.

21. The interface of claim 20 further comprising a link to a desktop application.

22. The interface of claim 21 in which the desktop application is a spreadsheet.

23. The interface of claim 21 in which the desktop application is a document.
